(19) United States
(12) Patent Application Publication
(10) Pub. No.: US 2024/0283078 A1
(43) Pub. Date: Aug. 22, 2024

(54) STEEL SHEET FOR TOP COVER OF BATTERY PACK AND ITS MANUFACTURING METHOD

(71) Applicant: ArcelorMittal, Luxembourg (LU)

(72) Inventors: Pascale SANZEY, Laquenexy (FR); Tiago MACHADO AMORIM, Longeville Les Metz (FR); Tarek KRIM, Metz (FR); Laurence DOSDAT, Rozérieulles (FR); Aurélie BESSON, Lironville (FR)

(21) Appl. No.: 18/292,729

(22) PCT Filed: Jun. 21, 2022
(86) PCT No.: PCT/IB2022/055751

§ 371 Date: Jan. 26, 2024

(30) Foreign Application Priority Data
Aug. 2, 2021 (WO) PCT/IB2021/057035

(51) Int. Cl. H01M 50/282; H01M 50/276

(52) U.S. Cl. CPC H01M 50/282; H01M 50/276; H01M 2220/20

(57) ABSTRACT

A top cover of battery pack including a metallic coated steel sheet wherein the metallic coating is based on zinc and includes aluminum, magnesium and unavoidable impurities.

The present invention deals with the housing elements of battery in the car industry. More specifically it relates to a top cover of a battery pack of an electric or hybrid vehicle having good resistance to fire exposure.

### BACKGROUND

Electrical vehicles or hybrid vehicles have to embed at least one heavy and bulky battery pack. This battery pack is made of a plurality of battery modules, each module containing battery cells. Said battery pack must be very well protected against thermal loads that may occur in case of accident, fire or any exposure to high temperature, be it during the assembly or during further life of the vehicle.

A current trend is to have bigger and bigger modules and even to store all the battery cells into a battery pack housing while leaving the intermediary containment into modules. The internal architecture of the battery pack can be composed of cells grouped into modules or made of a container directly including the battery cells and closed by a lid. Whatever the internal architecture of the battery pack, it is closed on its top face by an upper cover.

### SUMMARY OF THE INVENTION

As depicted on FIG. 1, a battery pack comprises from the bottom to the top:
A shield element 1;
An internal architecture of the battery pack including battery cells, and reinforcement parts optionally battery modules 2;
An upper cover also named top cover 3.

The top cover may be adhesively bonded and/or screwed together with other parts of the battery pack. It may also be connected to the internal architecture by any method of assembly such as welding.

Top cover can be made of aluminum sheets, for instance out of a 6000-series aluminum alloy and possibly from the specific AL 6016 alloy.

Fire hazards related to batteries are a major aspect regarding the safety in electric or hybrid vehicles. Especially thermal runaway, once started in one battery cell, produces enough heat to cause adjacent cells to also go into thermal runaway. This produces a fire that repeatedly flares up as each battery cell heats up, breaks, may explode and releases its content. The chemicals inside the battery heat up, which causes further degradation of any enclosures, be it the enclosure of cells, of the modules or of the whole battery pack. The flammable electrolyte can ignite or even explode when exposed to the oxygen in the air.

The top cover of the battery pack being the first separation between the battery cells and the passenger compartment, it is of major importance for fire resistance of battery packs. The top cover must ensure a safe separation between the battery pack and the passenger compartment even at high temperature. The top cover must also release few or no gas when submitted to high temperatures. Especially gases like CO2 or other vaporous combustion products may tremendously increase the pressure inside the battery pack when they are released inside the pack and heated by fire. This may induce opening of the pack, cracks through the housing and explosion.

The patent application US2019/0131602 discloses a housing for battery pack with a top cover. This cover plate is configured as a sandwich comprising at least a metal portion and a plastic portion, and wherein the metal portion is manufactured from at least one of steel and aluminum.

an aim of the present invention is to provide a top cover that has outstanding resistance to fire exposure, including risks of explosion.

The present invention provides a top cover of battery pack comprising a press stamped metallic coated steel sheet wherein said metallic coating is based on zinc and comprises aluminum, magnesium and unavoidable impurities. Another object of the invention is a battery pack including a top cover according to the invention.

Other characteristics and advantages of the invention will become apparent from the following detailed description of the invention.

### BRIEF DESCRIPTION OF THE DRAWINGS

To illustrate the invention, various embodiments and trials of non-limiting examples will be described, particularly with reference to the following figures:

FIG. 1 illustrates a battery pack and its top cover in an electric battery vehicle,

FIG. 2 illustrates a top cover according to the invention after fire exposure during 130 seconds at a temperature of 1300° C.

FIG. 3 illustrates a top cover not according to the invention after fire exposure during 130 s at 1000° C.

FIG. 4 illustrates a top cover according to the invention after fire exposure during 130 seconds at a temperature of 1000° C.

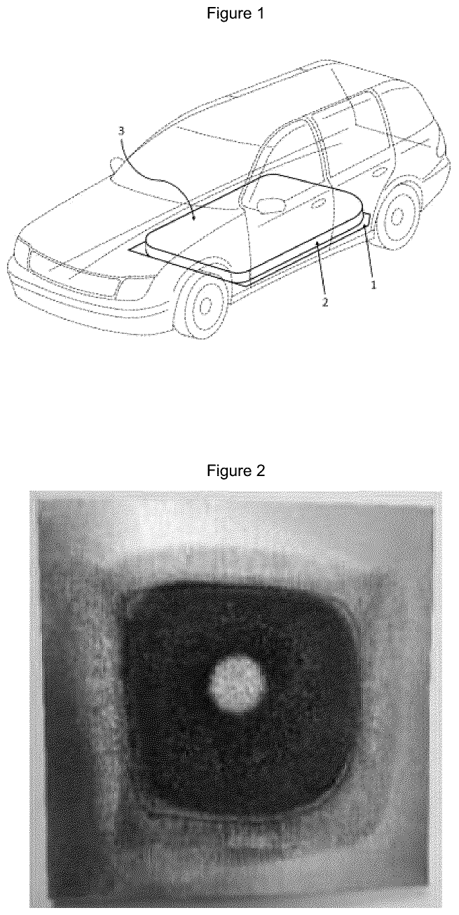

### DETAILED DESCRIPTION

The invention relates to a top cover for battery pack comprising a metallic coated steel sheet wherein said metallic coating is based on zinc and comprises aluminum, magnesium and unavoidable impurities.

For this purpose, any steel can be used in the frame of the invention. Preferably, steels having a good formability are well suited. For example, the top cover can be made of mild steel for deep drawing such as Interstitial Free steel having the following weight composition: C≤0.01%; Si≤0.3%; Mn≤1.0%; P≤0.1%; S≤0.025; Al≥0.01%; Ti≤0.12%; Nb≤0.08%; Cu≤0.2%.

For example, the top cover can be made of High Strength Low Alloy (HSLA) steel having the following weight composition: C≤0.1%; Si≤0.5%; Mn≤1.4%; P≤0.04%; S≤0.025%; Al≥0.01%; Ti≤0.15%; Nb≤0.09%; Cu≤0.2%.

The steel sheet can be obtained by hot rolling of a steel slab and subsequent cold rolling of the obtained steel coil, depending on the desired thickness, which can be for example from 0.6 to 1.0 mm.

The steel sheet is then coated with a metallic coating by any coating process. For examples, the steel sheet is hot-dip coated in a molten bath based on zinc and comprising aluminum, magnesium and unavoidable impurities.

The steel sheet can then be cut into a blank. It can be shaped by stamping to form the specific shape of the top cover.

The metallic coating used in the invention is based on aluminum and optionally comprises silicon and unavoidable impurities coming from the production process.

Such a coating is fireproof and does not release any gas when submitted to flame temperatures. In case of fire or high temperatures, it won't increase the pressure inside the battery pack.

In a preferred embodiment, the metallic coating comprises by weight from 1.5 to 10% of aluminum, from 1.5 to 10% of magnesium, the balance being zinc and unavoidable impurities. Such a metallic coating provides good resistance to corrosion.

For example, the metallic coating is Zagnelis® Protect with the following weight composition: contains 3.7% of aluminum and 3% of magnesium, the remainder being aluminum.

The metallic coating weight can be of 50 to 450 g/m² in total on both sides or less. For example, the metallic coating weight can be 120, 310 or 430 g/m².

For example, the metallic coating thickness on the inner side of the battery pack is 10 to 40 μm.

In a preferred embodiment, the surface of the metallic coating is topped by a passivation coating.

Passivation coatings can be applied on-line after the hot dip coating step with a roll-coat. It can also be applied on steel part by dipping. For both applications, an aqueous solution containing specific metallic passivating elements is deposited on the surface in form of a humid film. After drying, the passivation coating creates a conversion layer on the surface to provide enhanced corrosion protection.

For example, the passivation coating contains chromium and the chromium surface weight is from 15 to 45 mg/m². It can alternatively contain zirconium in the same amount.

The steel sheet can then be cut into a blank. The blank can be formed by press stamping to the specific shape of the top cover. This specific shape is design related. The top cover being a large horizontal part, it may be subject for vibrations. To reduce these vibrations and subsequent noise, stiffeners are generally punched into the top cover during the stamping operation. Finally, the top cover is attached to the pack by any removable or non-detachable means, for example by screwing, welding or gluing.

### EXAMPLES

In order to determine the resistance to fire of the top covers, several tests were performed. All tests were performed on the same test device.

The test device was adapted from the test device described in the Standard ISO 2685:1998. Both following adaptations were done: Firstly, the sample was thermally isolated from the structure of the test device by a 10 mm thick plate of calcium silicate. Secondly, the gas burner generating the flame has been calibrated to achieve the targeted temperature on the face of the sample that is exposed to the flame.

For all tests, the samples have the same dimension of 150×150 mm². Each sample is positioned in front of the gas burner to get hit by the flame. The plate between the sample and the burner has an opening area with the dimension of 90×90 mm².

Three materials were tested:

material 1 is a 0.7 mm thick steel sheet. It is coated with Zagnelis® Protect. This hot-dip coating contains by weight 3.7% of aluminum and 3% of magnesium, the remainder being aluminum. The coating weight is 310 g/m². After hot dip coating, the surface has been passivated by roll-coat application of Bonderite® MPA 6010 from supplier HENKEL which contains Chromium (III) ions. It has been then dried by blowing of hot air. The surface weight of chromium on the dried surface is from 25 to 35 mg/m².

material 2 is a 1.0 mm thick aluminum sheet of 6016 series.

material 3 is a 0.8 mm galvanized steel sheet coated with epoxy-based e-coat. The hot-dip coating contains up to 0.2 of aluminum by weight, the remainder being zinc. The metallic coating weight is 140 g/m². After a phosphating step, the sample was dipped in a e-coating bath. The e-coat tested is Powercron® 6200 HE from supplier PPG. The dry thickness of paint after baking is 25 μm on each face.

material 4 is 0.8 mm thick steel sheet having the same metallic coating and passivation as material 1

In the following, sample 1 is made of material 1, sample 2 is made of material 2 and sample 3 is made of material 3, sample 4 of material 4.

Two scenarios of fire exposure have been tested. In scenario A, the flame temperature is 1300° C. and the exposure time is 130 s. In scenario B, which is less severe, the flame temperature is 1000° C., and the time exposure is first 20 s directly followed by a 60 s time of flame extinction with a final exposure of 10 s.

Several criteria are considered for analysis of the tests. The integrity of the sheet, i. e. whether the flame has pierced the sheet or not, the temperature of the face unexposed to the flame (back-face) at the end of the test and the presence of bubbles in the coating after the test. The presence of a bubble shows the release of gas.

TABLE 1
Scenarios of flame exposure

| Scenario | Time of flame exposure | Temperature of flame |
|---|---|---|
| A | 130 s | 1300° C. |
| B | 130 s | 1000° C. |

TABLE 2
Scenario A: 130 s at 1300° C.

| Scenario | | | Temperature on back- | Presence |
|---|---|---|---|---|
| A | Sample | Flame Piercing | face after 130 s | of bubbles |
| 1300° C. | 1* | No | 615° C. | No |
| 130 s | 2 | Yes after 45 s | above 910° C. | — |

After an exposure of 130 s at 1300° C., the back-face of sample 1 made of steel remains at a temperature of less than 700° C. and doesn't show any signs of melting. On the contrary, the flame has pierced material 2 made of thicker aluminum.

Moreover, sample 1 doesn't show any bubbles as can be seen on FIG. 2. Its coating didn't release gas.

TABLE 3
Scenario B: 130 s at 1000° C.

| Scenario | | | Temparature on back- | Presence |
|---|---|---|---|---|
| B | Sample | Flame Piercing | face after 130 s | of bubbles |
| 1000° C. | 3 | No | 486° C. | Yes |
| 130 s | 4* | No | 590° C. | No |

After an exposure of 130 s at 1000° C., the back-face of sample 3 clearly shows bubbles as can be seen on FIG. 3. These open bubbles have released combustion products of the paint in form of gas.

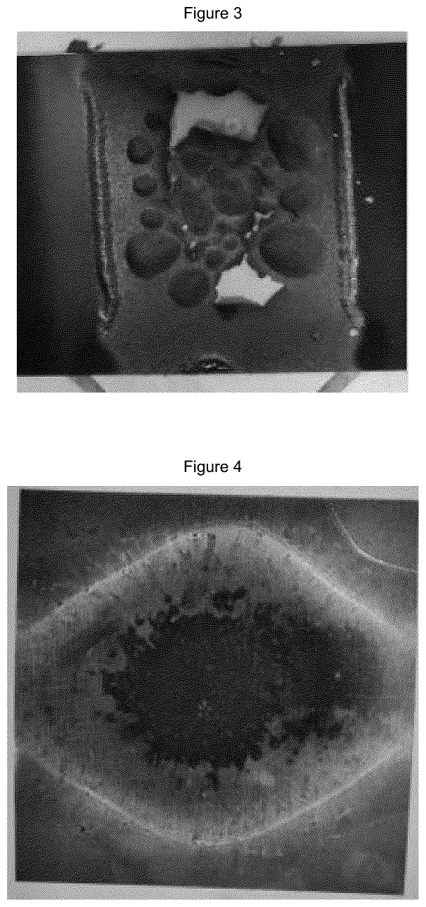

Sample 4 doesn't show any bubbles as can be seen on FIG. 4

What is claimed is:

1-6 (canceled).

7. A top cover of a battery pack comprising:
a press stamped metallic coated steel sheet including a steel sheet with a metallic coating, the metallic coating being based on zinc and comprising aluminium, magnesium and unavoidable impurities.

8. The top cover as recited in claim 7 wherein the metallic coating is topped by a passivation metallic coating wherein a surface weight of a passivating element is from 5 to 50 mg/m².

9. The top cover as recited in claim 7 wherein the metallic coating comprises by weight from 1.5 to 10% of aluminium, from 1.5 to 10% of magnesium, a balance being zinc and the unavoidable impurities.

10. The top cover as recited in claim 7 wherein the metallic coating has a thickness of 10 to 40 μm on an inner side of the battery pack.

11. The top cover as recited in claim 7 wherein the metallic coated steel sheet has a metallic coating weight of 50 to 450 g/m² in total on both sides.

12. A battery pack comprising the top cover as recited in claim 7.
